(19) United States
(12) Patent Application Publication
(10) Pub. No.: US 2007/0101601 A1
(43) Pub. Date: May 10, 2007

(54) Device "Tool" to "Grade" sewer line/drain lines under crawl spaces "Drop-Shot" tool

(76) Inventor: James Lee Ortiz, Las Vegas, NM (US)

Correspondence Address: JAMES L. ORTIZ, 704 Catalina Ct., Las Vegas, NM, 87701, US

(21) Appl. No.: 11/207,625

(22) Filed: Nov. 4, 2005

(51) Int. Cl. G01B 3/08

(52) U.S. Cl. 33/809

(57) ABSTRACT

The invention will simplify Plumbing Rough-In measurements for drop to grade on Building sewer systems within residential homes as well as commercial buildings Where allowed. This tool will enable the Plumber to perform residential sewer System calculations for drops within basements, where crawl space is limited. Also, tool will be easy to use on second floor dwellings. Individual Plumber Example usage: If you are working alone and need to drop a sewer (drain line), 20 feet. Example: 3″ sewer pipe running 20 feet at ¼ inch per foot drop, would Equal to 5 inches drop. One Plumber can set Drop-Shot Tool at 5 inches drop And get his/her drop at 20 feet. Drop-Shot Tool can be used for pipe sized 2″ Thru 4″, and reverse side can be used for ⅛″ drop for pipe bigger than 4 inches. Drop will always comply with Uniform Plumbing Codes and save time, money, And always enable the contractor/Plumber to be in compliance of local, state and Other Plumbing Codes.

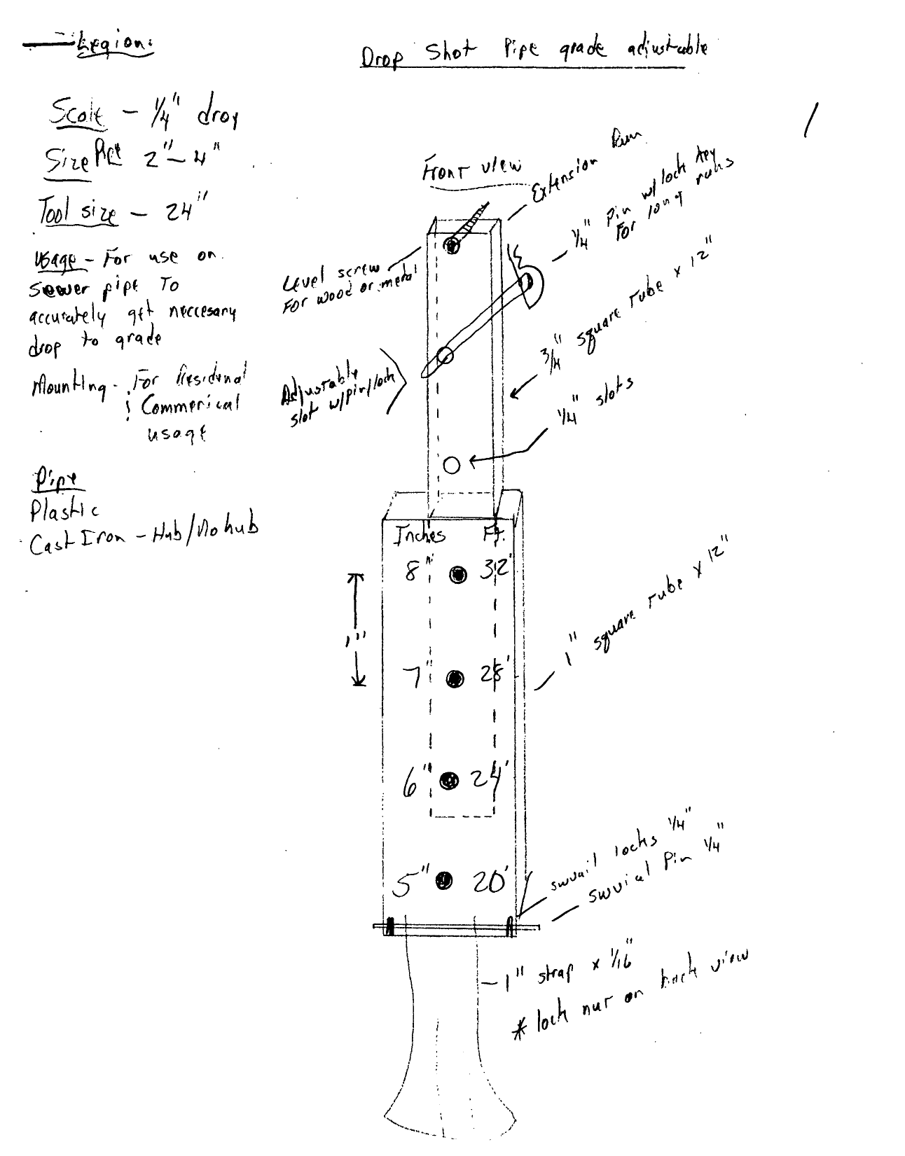

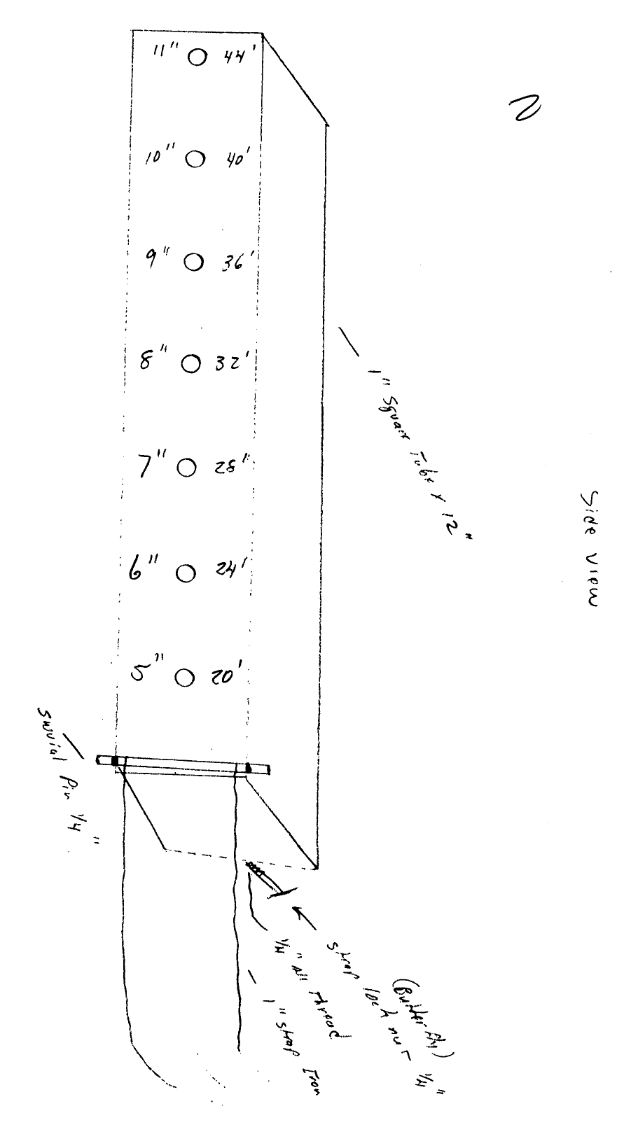

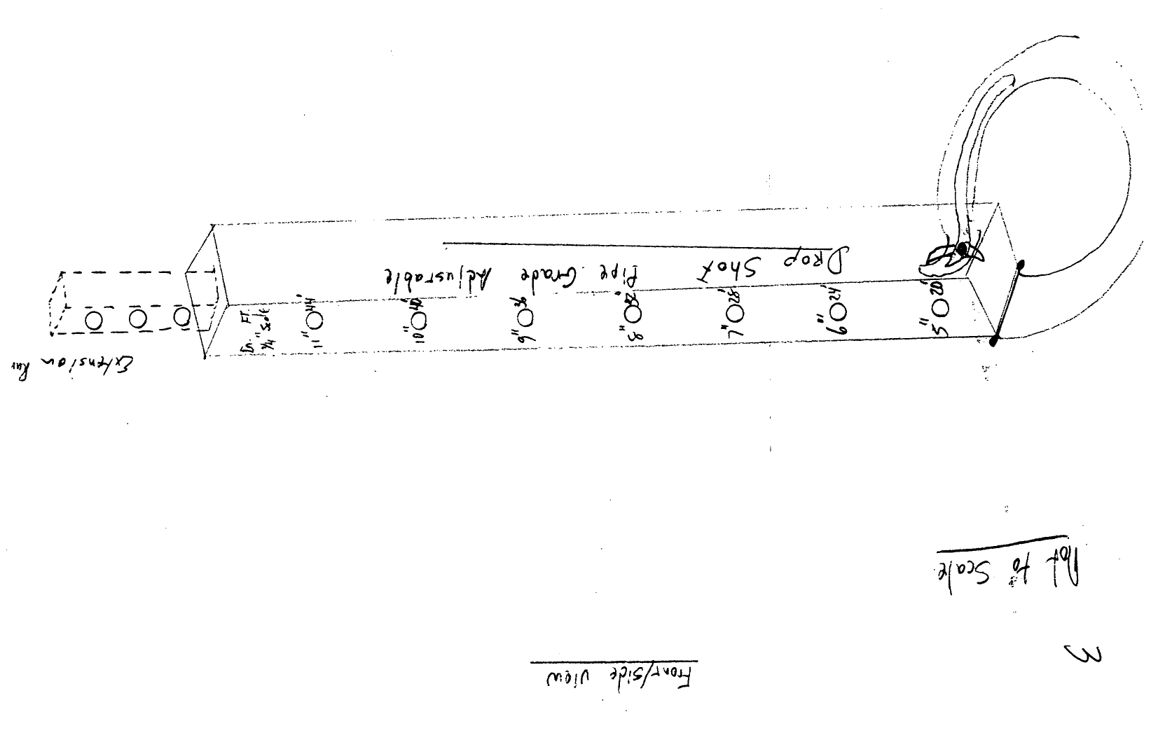

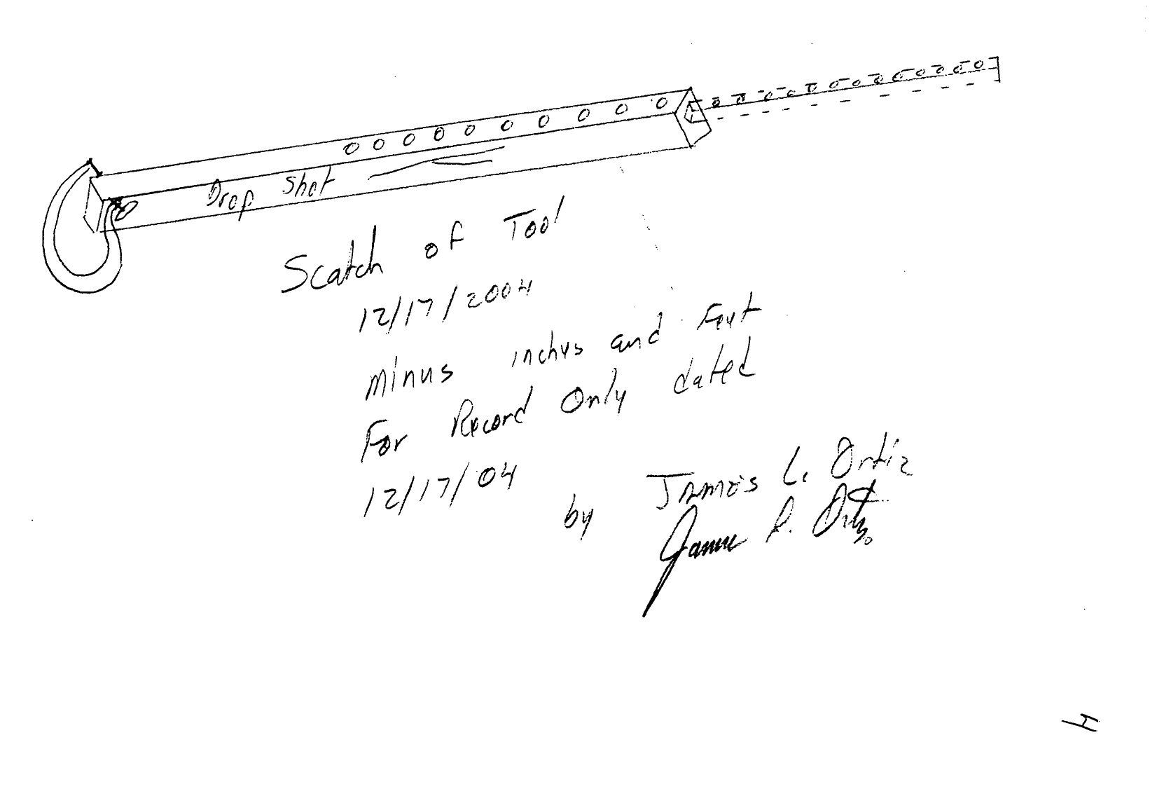

The invention will simplify Plumbing Rough-in measurements for drop to grade on building Sewer systems within residential homes as well as commercial buildings where allowed. This tool will enable the Plumber to perform residential sewer system calculations for drops Within basements, where crawl space is limited. Also, tool will be easy to use on second Floor dwellings. Individual Plumber example usage: If you are working alone and need To drop a sewer (drain line) 20 feet at ¼ inch drop per foot, this tool (Drop-Shot) will Attach to rough floor brace and measure out 20 feet. Example: 3″ sewer pipe running 20 Feet at ¼ inch per foot drop would equal to 5 inches drop. One Plumber can set Drop-Shot Tool at 5 inches drop and get his/her drop at 20 feet. Drop-Shot Tool can be used for pipe Sized 2″ thru 4″ and reverse side can be used for ⅛ inch drop for pipe bigger than 4″. Drop will always comply with Uniform Plumbing Codes and save time, money and always Enable the Contractor Plumber to be in compliance of local, state and other Plumbing Codes.

### LEGION

Scale: ¼ Drop & ⅛ Drop (larger Pipe)

Size of Pipe: 2″ thru 4″

Drop-Shot Pipe Grade Adjustable TOOL Size—24 inches Total

Usage: For use on Sewer pipe for accurate drop to grade

Mounting: For Residential 7 Commercial Usage

Pipe: Plastic or Castiron Hub/No-hub

Front View:

Extension Run

Level screw For wood or metal studs

Adjustable slot with pin or lock

¼ inch pin with lock key for long runs

¼ inch round slots

¾ inch square tube×12 inches

1 inch square tube×12 inches

Swvail locks ¼ inch

Swvial pin ¼ inch

1 inch metal or leather strap× 1/16 inch

* lock nut on back view

** Note: Front View is for ¼ inch Drop-Shot Description only

5 inches at ¼ inch drop equals to 20 feet grade

6 inches at ¼ inch drop equals to 24 feet grade

7 inches at ¼ inch drop equals to 28 feet grade

8 inches at ¼ inch drop equals to 32 feet grade

Side View:

1 inch square tube×12 inches

¼ inch swvial pin

Strap lock nut ¼ inch

¼ inch all thread bolt

1 inch strap iron× 1/16 inch or leather strap

5 inches at ¼ inch drop equals to 20 feet

6 inches at ¼ inch drop equals to 24 feet

7 inches at ¼ inch drop equals to 28 feet

8 inches at ¼ inch drop equals to 32 feet

9 inches at ¼ inch drop equals to 36 feet

10 inches at ¼ inch drop equals to 40 feet

11 inches at ¼ inch drop equals to 44 feet

1- Invention will simplify Plumbing Rough-in Building Sewer Drain Systems.

2- Invention will enable Independent Plumbing Contractor to Rough-in systems as a one Person team.

3- Accurate measurements will comply with Inspector and Code requirements.

4- Simple to understand by certified & Licensed Plumber.

5- Steel stamped for longevity and recognition of measurement numbers.
